(19) United States
(12) Patent Application Publication
(10) Pub. No.: US 2023/0081411 A1
(43) Pub. Date: Mar. 16, 2023

(54) RECLOSEABLE PACKAGE WITH IMPROVED OPENING FEATURE

(71) Applicant: James W. Yeager, Inlet Beach, FL (US)

(72) Inventor: James W. Yeager, Inlet Beach, FL (US)

(21) Appl. No.: 17/944,369

(22) Filed: Sep. 14, 2022

Related U.S. Application Data
(60) Provisional application No. 63/244,032, filed on Sep. 14, 2021.

(51) Int. Cl. B65D 33/25; B65D 33/18; B31B 70/16; B31B 70/81

(52) U.S. Cl. CPC B65D 33/2575; B65D 33/18; B31B 70/16; B31B 70/813; B31B 2155/00

(57) ABSTRACT

A recloseable package is provided having a recloseable fastener assembly positioned on an inside surface of a front wall of the package. An openable region defined by the front wall of the package provides access to the recloseable fastener assembly and the package contents. The openable region typically comprises perforations or scoring. In order to facilitate such access during initial opening of the package by separation of profile strips of the fastener assembly, an access opening defined by the front wall of the package is provided at the openable region. At least one of the profile strips of the fastener assembly can be provided with a stand-off projection, which can be accessed through openable region. The projection desirably acts to separate the profile strips of the fastener assembly, to facilitate gripping and manipulation of the fastener assembly to facilitate its convenient use. Notably, this projection can be configured be deformable, to facilitate manipulation and separation of the profile strips of the fastener assembly. Additionally, a free edge portion of one of the profile strips can be colored so that the free edge portion is readily visually discernible through the access opening. Convenient opening of the openable region is thus facilitated.

### CROSS-REFERENCE TO RELATED APPLICATIONS

This application claims priority of Provisional Ser. No. 63/244,032, filed Sep. 14, 2021, the disclosure of which is hereby incorporated by reference in its entirety.

### FEDERALLY SPONSORED RESEARCH OR DEVELOPMENT

Not Applicable.

### MICROFICHE/COPYRIGHT REFERENCE

Not Applicable.

### FIELD OF THE INVENTION

The present invention relates generally to polymeric film packages and bags, and more particularly to a recloseable package having a recloseable fastener assembly provided on a front wall of the package, with features of the invention facilitating access to, and manipulation of, the recloseable fastener assembly.

### BACKGROUND OF THE INVENTION

Polymeric film packages are used for a very wide variety of packaging applications, and have proven particularly versatile for packaging of food products and the like. Such packaging typically comprises heat-sealable polymeric film which can be economically employed for such applications. Frequently, package formation is effected in conjunction with packaging of a product, such as by use of so-called form, fill and seal machines. For some applications, packages can be pre-made, for subsequent filling.

Convenient use of such packages by consumers is facilitated by configuring a package to be recloseable after initial opening. Fastener assemblies comprising releasable interlocking profile strips can be economically employed for this purpose, permitting a package to be opened and closed by separation and connection of the profile strips.

U.S. Pat. No. 6,079,878, hereby incorporated by reference, illustrates one such recloseable package. In this construction, a recloseable fastener assembly is joined to the inside surface of the front wall of a package, with access to the assembly provided by a frangible, openable region of the front wall aligned with the fastener assembly. Such an openable region may comprise perforations, scoring, or like arrangements whereby the openable region is preferentially weakened. U.S. Pat. No. 5,461,845, hereby incorporated by reference, discloses methods of manufacturing packages of this type.

Although U.S. Pat. No. 6,079,878 in combination with U.S. Pat. No. 5,461,845 have proven to be commercially successful, the shortcomings of these arrangements has proven to be the relative difficulty in accessing the closure, i.e., fastener assembly, through the front wall of the package. Unlike the more common opposing wall closure designs, the user cannot access the closure by cutting open the top of the package, but instead must access the closure through some opening means in the front panel of the package.

The present invention will disclose a new and improved front panel opening feature in combination with an improved closure design that will assist the user to tear open the film of the front panel. In addition the design of the present invention makes it easier to manipulate the closure when opening the package.

The design of the present invention includes an access opening in the front panel of the package for accessing the closure without the need to tear open the film of the front panel to gain access to the closure. This eliminates issues of tearing open the front panel of the package to access the closure when using films that do not exhibit tear properties that facilitate manual opening. Specifically, some films are either too tough or too brittle to perforate, and open successfully when making packages.

The present invention also includes a novel closure design that includes a stand-off feature that keeps the flanges of the fastener assembly separated from one another so that it is easier for the user of the package to grip the near side flange which is needed to open a front panel recloseable package. This makes it easier to open the closure by manipulation of the flanges since the flanges are normally separated from one another by the addition of the stand-off feature. Front panel closure designs often use a peelable seal means between the flanges to make the closure hermetic which makes the flanges even more difficult to separate when using and therefore in more need of the stand-off feature of the present invention.

The present invention may also include a color line along the top edge of the near side flange of the closure. This color line is visible through the opening of the front panel making it easier for the user to find and open the closure.

For some applications, the polymeric film material from which such packages are formed may comprise a lamination, and can include multiple film layers in order to achieve the desired performance characteristics for the package, such a specified resistance to gas passage, or the like. However, the use of such multi-layer polymer films, or other relatively strong films, can inhibit fracture or other opening of the front wall of the package in order to gain access to the recloseable fastener for initial opening of the package.

The present invention provides features for a recloseable package of this type to facilitate access to, and manipulation of, a recloseable fastener assembly provided on the inside surface to the package front wall.

### SUMMARY OF THE INVENTION

In accordance with the present invention, a recloseable package is provided having a recloseable fastener assembly positioned on an inside surface of a front wall of the package. An openable region defined by the front wall of the package provides access to the recloseable fastener assembly. The openable region typically comprises perforations or scoring.

In order to facilitate such access during initial opening of the package, an access opening, formed in the package prior to filling, is defined by the front wall of the package. In one embodiment of the present invention, the front wall of the package includes a folded gripping tab, formed by a folded portion of the front wall, at the openable region. Notably, the access opening facilitates access to the fastener assembly through the front wall so the assembly can be manipulated for convenient opening of the openable region. Convenient access to the package contents is thus facilitated.

In the illustrated embodiments, at least one of the profile strips of the fastener assembly is provided with a stand-off projection, positioned generally at the access opening of the package. The stand-off projection desirably acts to facilitate manipulation, separation and gripping of the profile strips of the fastener assembly through the access opening. Convenient use is thus facilitated.

A recloseable package in accordance with the present invention comprises a package body formed from at least one rectangular sheet of film material. The package includes a top end, a bottom end, a front wall, and a back wall, with the front wall being joined to the back wall by upper and lower heat-sealed seams respectively provided at the top and bottom ends of the package body.

A recloseable fastener assembly is joined by heat-sealing to an inside surface of the front wall, and comprises first and second interlocking profile strips respectively extending along the length of the fastener assembly. The profile strips are configured for releasable interlocking engagement with each other by the provision of respective interlocking features comprising at least one protuberance on one of the profile strips, and at least one groove defined by the other of the profile strips for respectively releasably receiving the protuberance.

In the illustrated embodiments, the first profile strip includes a body flange portion joined at a first seal to the front wall of the package body, and the second profile strip includes another body flange portion joined at a second seal to the front wall of the package body, with the second seal located on the front wall above the first seal. A peelable seal is provided between the flange portions of the of the profile strips for tamper-evidence and to maintain the freshness of the package contents.

An elongated openable region is defined in the front wall, in alignment with the fastener assembly for providing access to the fastener assembly after opening of the openable region. In the illustrated embodiments, the front wall of the package body defines an arcuate access opening positioned laterally centrally of the front wall to facilitate access to the recloseable fastener assembly.

In accordance with one aspect of the present invention, the front wall of the package body includes a folded gripping tab, comprising a folded portion of the front wall, at the openable region. In this illustrated embodiment, the folded gripping tab is formed in the front wall adjacent an upper edge of the first profile strip, to thereby facilitate access to the fastener assembly through the access opening of the front wall of the package body. The provision of the folded gripping tab facilitates grasping of the front wall and the first profile strip of the fastener assembly to facilitate manipulation and separation of the profile strips. Opening of the openable region of the front wall, such as by tearing the perforations therein is thus facilitated.

The folded portion of the front wall that forms the gripping tab is cut from the film material of the front wall, prior to folding, to define the access opening. In an alternative embodiment, a portion of the film material from which the front wall is formed is cut and removed to form the access opening. Thus, the access opening is formed in front wall of package body prior to placing contents in the package.

To further facilitate convenient gripping, grasping, and manipulation of the fastener assembly, the present invention contemplates that at least one of the profile strips of the fastener assembly include a stand-off projection feature positioned above the interlocking feature of the respective profile strip. The stand-off projection preferably is coextensive with the interlocking feature of the respective profile strip, and desirably acts to separate the flange portions of the profile strips. This facilitates gripping of the profile strips of the fastener assembly, and thus facilitates opening of the fastener assembly by separation of the profile strips thereof, while also facilitating tearing and fracture of the openable region in the front wall of the package. This arrangement further facilitates unsealing and opening of the peelable seal provided between the profile strips of the fastener assembly.

In accordance with the present invention, a method of making a recloseable package comprises the first step of providing at least one rectangular sheet of film material. Notably, the present method further includes forming an openable region in the sheet of film material, including cutting the sheet of film material to form an access opening. In one embodiment, the film material cut from the access opening forms a gripping tab, with the method including folding the gripping tab to form a folded gripping tab. In an alternative embodiment, the material cut from the access opening is removed.

Thereafter, a recloseable fastener assembly is joined to the sheet of film material at the openable region. Package formation is completed by folding the sheet of film material to form a package body having a top end, a bottom end, a front wall, and a back wall, with the front wall joined to said back wall by upper and lower heat-sealed seams respectively provided at the top and bottom ends. The recloseable fastener assembly is thus joined to an inside surface of the front wall, with the recloseable fastener assembly accessible through the access opening. The optional provision of the folded gripping tab facilitates such manipulation of the fastener assembly through the access opening.

In accordance with another illustrated embodiment of the present invention, a recloseable package comprises a package body as described above, including top end, a bottom end, a front wall and a back wall. Upper and lower seals are respectively at the top and bottom ends.

In this embodiment, a recloseable fastener assembly is joined to an inside surface of the front wall, and comprises first and second interlocking profile strips configured for releasable interlocking engagement with each other.

As in the previous embodiment, the first profile strip includes a body flange portion joined at a first seal to the front wall of the package body, and the second profile strip includes another body flange portion joined at a second seal to the front wall of the package body, wherein second seal is located above the first seal. A peelable seal is provided between the flange portions of the of the profile strips for tamper-evidence and to maintain the freshness of the package contents.

The recloseable package includes an elongated openable region defined in the front wall aligned with the fastener assembly for providing access to the fastener assembly after opening of the openable region.

The front wall of the package body further defines an access opening positioned laterally centrally of the front wall, with the access opening formed in the front wall adjacent an upper edge of the first profile strip. The access opening facilitates access to the fastener assembly through the front wall of the package body.

As noted, in this embodiment, a portion of the film material from which the front wall formed is removed from the front wall during package manufacture to define the access opening. Thus, the material which is cut from the access opening is not folded to form a folded gripping tab, as in the previous embodiment.

To facilitate manipulation of the fastener assembly, at least one of the body flange portions of the first and second profile strips includes at least one stand-off projection engageable with the other one of the body flange portions. This stand-off projection, which can optionally be deformable, functions to facilitate manipulation and separation of the profile strips of the fastener assembly, while also facilitating tearing and opening of the openable region in the front wall of the package. The one or more stand-off projections desirably act to separate the body flange portions from each other. Manipulation of the fastener assembly through the access opening is facilitated.

In accordance with the present invention, the fastener assembly of the package preferably includes at least one peelable seal releasably joining the body flange portions of the assembly. The peelable seal is positioned: beneath the at least one stand-off projection, and above the interlocking features of the first and second interlocking profile strips. The stand-off projection facilitates manipulation of the fastener assembly to facilitate separation of the body flanges portions to open the peelable seal, separate the interlocking features of the fastener assembly, and tear the openable region of the front wall to permit access to the contents of the package.

In accordance with this embodiment, the at least one stand-off projection can be deformable from: a first position to maintain spacing between the body flanges portions, to a second position wherein the body flange portions are more closely spaced together. This arrangement facilitates reengagement of the interlocking features of the fastener assembly, thereby permitting the package to be reclosed after initial opening.

In certain illustrated embodiments, a pair of the stand-off projections are provided. In one embodiment, the projections are respectively positioned on the body flange portions of the fastener assembly. In another illustrated embodiment, the projections have generally V-shaped configuration, while in another embodiment the stand-off projection has a generally T-shaped cross-sectional configuration. These arrangements permit the projections to readily deform between the first and second positions thereof. This permits the flange portions of the fastener assembly to be placed together, thereby permitting the interlocking features of the fastener assembly to be secured together to reclose the package after initial opening to thereby

For some applications it can be desirable to configure the body flange portion of the second profile strip to include an opaque region viewable through the access opening defined by the front wall of the package body. This opaque region can be colored or tinted, and/or provided with indicia to facilitate opening of the present package. It can also be desirable to provide the first profile strip with a colored, free edge portion, adjacent to and viewable through the access opening in the front wall, so users can readily identify the region of the fastener which can be gripped for opening the package.

In accordance with the present invention, the recloseable fastener assembly is secured to the front wall of the package body by a perimeter seal extending generally about the interlocking features of the fastener assembly. The perimeter seal has a first leg extending below the interlocking features of the assembly, and a second leg extending above the interlocking features. The fastener assembly is further secured to the front wall by a pair of bridge seals extending between the first and second legs of the perimeter seal, with the bridge seals positioned on respective opposite sides of the access opening defined by the front wall of the package body.

In accordance with the present invention, a recloseable fastener assembly, or closure, comprises first and second interlocking profile strips respectively extending along the length of the fastener assembly.

The profile strips are configured for releasable interlocking engagement with each other by the provision respective interlocking features comprising at least one protuberance on one of the profile strips, and at least one groove defined by the other of the profile strips for respectively releasably receiving the protuberance. The first profile strip includes a body flange portion, and second profile strip includes another body flange portion.

In accordance with the present invention, at least one of the body flange portions of the profile strips of the fastener assembly includes at least one deformable stand-off projection engageable with the other one of the body flange portions of the fastener to facilitate manipulation of said fastener assembly. The at least one stand-off projection is deformable from: a first position to maintain spacing between the body flanges portions, to a second position wherein the body flange portions are more closely spaced together.

The fastener assembly further includes at least one peelable seal releasably joining the body flange portions. The peelable seal is positioned intermediate the at least one stand-off projection, and the interlocking features of the first and second interlocking profile strips.

In one illustrated embodiment a pair of the stand-off projections are respectively positioned on the body flange portions of the fastener assembly. In another illustrated embodiment, a pair of the projections have a generally V-shaped configuration. In another embodiment, the stand-off projection has a generally T-shaped cross-sectional configuration. These arrangements permit the stand-off feature to readily deform between the first and second positions thereof.

Optionally, the body flange portion of at least one of the profile strips can include an opaque region which is visually discernible from the remainder of that body flange portion.

Optionally, a free edge portion of at least one of the flange portions of the profile strips of the fastener assembly is colored to facilitate visual detection of said fastener assembly. This free edge can be positioned at and viewable through the access opening of an associated package to facilitate opening of the package.

In accordance with the present invention, a method of opening a package includes the step of providing a recloseable package as described above, including providing an access opening in a front wall of the package, prior to filling the package. The method further includes providing a peelable seal between flange portions of a fastener assembly of the package

The present method further includes accessing first and second profile strips of the fastener assembly through the access opening in the front wall to facilitate separation of profile strips of the fastener assembly, and unsealing of the peelable seal, to gain access to the contents of the package through an openable region of the package front wall. In the preferred practice, the method of opening includes providing the profile strip positioned at the access opening with a free edge portion colored to facilitate visual detection of the fastener assembly.

Other features and advantages of the present invention will be readily apparent from the following detailed description, the accompanying drawings, and the appended claims.

### BRIEF DESCRIPTION OF THE DRAWINGS

FIG. 1 is a diagrammatic perspective view of a recloseable package having improved opening features embodying the principles of the present invention:

FIG. 2 is a cross-sectional view taken along lines 2-2 in FIG. 1;

FIG. 3 is a diagrammatic view illustrating a method of practicing the present invention for forming a recloseable package;

FIG. 4 is a side view similar to FIG. 3 further illustrating the method of the present invention;

FIG. 5 is a diagrammatic perspective view of alternative embodiment a recloseable package having improved opening features embodying the principles of the present invention;

FIG. 6 is a cross-sectional view taken along lines 6-6 in FIG. 5;

FIGS. 7A and 7B are diagrammatic cross-sectional views similar to FIG. 6 showing features of a further embodiment of the present invention;

FIG. 8 is a diagrammatic cross-sectional view similar to FIGS. 7A and 7B showing a further embodiment of the present invention; and

FIG. 9 is a diagrammatic cross-sectional view similar to FIG. 6 showing features of a further embodiment of the present invention.

### DETAILED DESCRIPTION OF THE PREFERRED EMBODIMENT

While the present invention is susceptible to embodiment in various forms, there are shown in the drawings, and will hereafter be described, presently preferred embodiments, with understanding that the present disclosure is intended as an exemplification of the invention, and is not intended to limit the invention to the specific embodiments illustrated herein.

In accordance with the present invention, a recloseable package is provided having a recloseable fastener assembly, sometimes referred to as a closure, positioned on an inside surface of a front wall of the package. An openable region defined by the front wall of the package provides access to the recloseable fastener assembly, and opening of the front wall to gain access to the package contents. The openable region typically comprises perforations or scoring.

In order to facilitate such access during initial opening of the package, the front wall of the package defines an access opening, and can include a folded gripping tab, formed by a folded portion of the front wall, at the openable region. Convenient opening of the openable region is thus facilitated.

In the illustrated embodiments, at least one of the profile strips of the fastener assembly is provided with a stand-off projection feature which acts to maintain separation of the profile strips, thus facilitating gripping and manipulation of the fastener assembly to facilitate its convenient use, while facilitating tearing, fracture and opening of the openable region in the front wall of the package. The stand-off projection can be deformable to facilitate subsequent closing of the package, and re-attachment of the interlocking features of the fastener assembly, as will be further described.

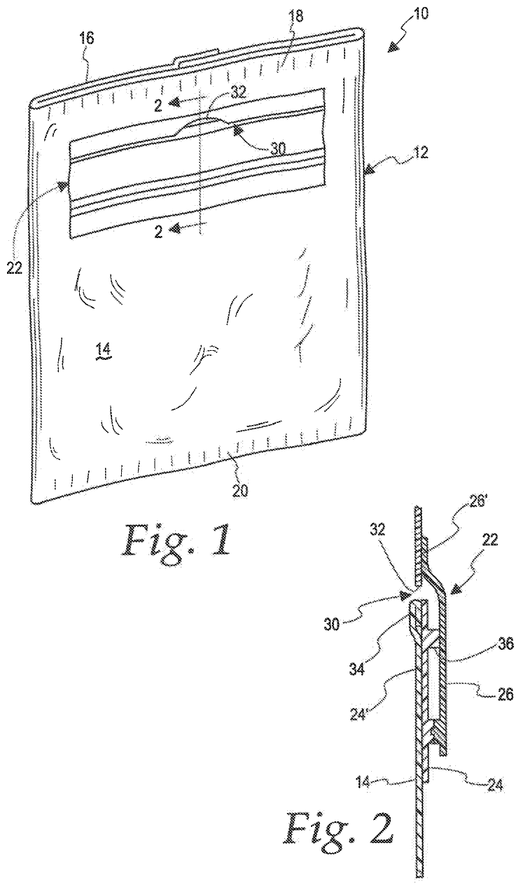

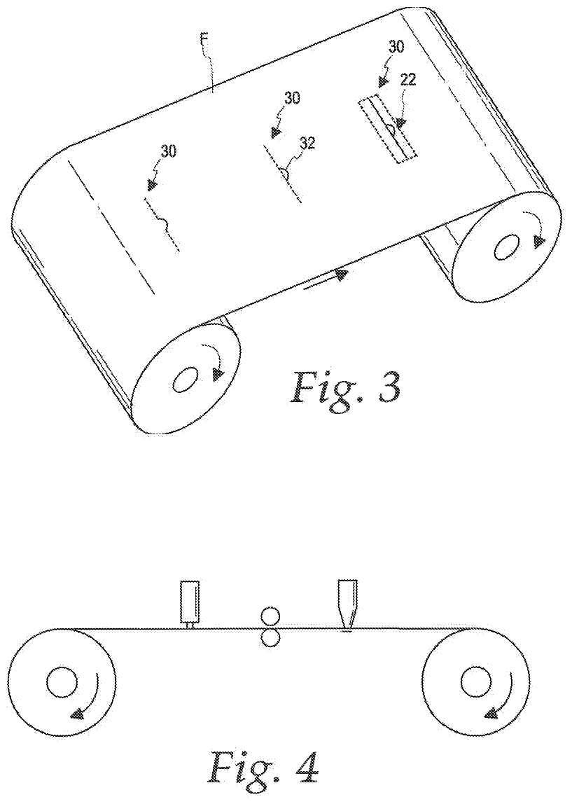

With reference first to FIGS. 1 and 2, a recloseable package 10 in accordance with the present invention comprises a package body 12 formed from at least one rectangular sheet of film material. The package body 12 includes a top end, a bottom end, a front wall 14, and a back wall 16, with the front wall 14 being joined to the back wall 16 by upper and lower heat-sealed seams 18,20 respectively provided at the top and bottom ends of the package body 12.

A recloseable fastener assembly 22 is joined by heat-sealing to an inside surface of the front wall 14, and comprises first and second interlocking profile strips 24,26 respectively extending along the length of the fastener assembly. The profile strips 24,26 are configured for releasable interlocking engagement with each other by the provision of respective interlocking features comprising at least one protuberance on one of the profile strips, and at least one groove defined by the other of the profile strips for respectively releasably receiving the protuberance.

In the illustrated embodiment, the first profile strip 24 includes a body flange portion joined at a first seal 24′ to the front wall 14 of the package body 12. The second profile strip 26 includes another body flange portion joined at a second seal 26′ to the front wall 14 of the package body 12, with the second seal 26′ located on the front wall above the first seal 24′. The body flange portions of the profile strip typically include sealant layers which facilitate heat-sealing of the profile strips at temperatures less than would be required for heat-sealing the strips themselves.

An elongated openable region 30 is defined in the front wall 14, in alignment with the fastener assembly 22. The openable region 30 provides access to the package contents, through the separated profile strips of the fastener assembly 22, after opening of the openable region 30.

In accordance with the present invention, the front wall 14 of the package body 12 defines an arcuate access opening 32 positioned laterally centrally of the front wall 14 to facilitate access to and manipulation of the fastener assembly 22. In one form of the present invention, a folded portion of the film material from which front wall 14 is formed is folded to provide a folded gripping tab 34, which is positioned at the access opening 32. The folded gripping tab 34 is cut from the film material prior to folding of the film to form the package body, and thereby define the access opening 32. As will be further described, in an alternative embodiment, a portion of the film material from which the front wall 14 is formed is cut and removed to form the access opening 32. Thus, the access opening 32 is formed in front wall 14 of package body 12 prior to folding of the film material to form the package body, and thus prior to placing contents in the package such as by use of a form fill and seal apparatus for package filling.

The folded gripping tab 34 is formed in the front wall 14 adjacent an upper edge of the first profile strip 24. This arrangement thereby facilitates access to the fastener assembly 22 through the openable region 30 of the front wall. The provision of the folded gripping tab 34 facilitates grasping of the front wall 14 and the first profile strip 24 of the fastener assembly 22 to facilitate separating the profile strips, and opening of the openable region 30 of the front wall 14, such as by tearing the perforations therein. Grasping and manipulation of the fastener assembly 22 for opening the assembly is thus facilitated.

To further facilitate convenient gripping, grasping, and manipulation of the fastener assembly 22, the present invention contemplates that at least one of the profile strips 24,26 of the fastener assembly 22 include a stand-off projection 36 positioned above the interlocking feature of the respective one of the of profile strips. The stand-off projection 36, which preferably is coextensive with the interlocking feature of the respective profile strip 24, desirably acts to separate the flange portions of the profile strips of the fastener assembly 22. This facilitates gripping of the profile strips of the fastener assembly, while also facilitating gripping of the front wall 14 of the package at the openable region 30. This facilitates opening of the fastener assembly 22 by separation of the profile strips 24,26 thereof, while also facilitating tearing and fracture of the front wall 14 of the package body at the openable region 30. Tearing of laminated films and the like from which the package can be formed is facilitated by this arrangement, which permits both the fastener assembly, and the front wall of the package to be firmly grasped and manipulated.

As will be further described, the stand-off projection 36 can be configured to be deformable, which further facilitates manipulation of the profile strips of the fastener assembly, particularly for reattachment of the strips after initial opening of the package.

In accordance with the present invention, a method of making a recloseable package 10 comprises the first step of providing at least one rectangular sheet of film material F. As will be recognized by those familiar with the art, formation in this manner can be effected in conjunction with package filling, such as with a so-called form, fill and seal apparatus. Thus, the rectangular piece of film from which the package is formed is typically a portion of a substantially continuous film web. Attendant to package formation, the film web is folded to form the package body, and contents placed in each package being formed, with each package ultimately sealed and cut from the film web to form separate, filled packages.

Notably, the present method further includes forming an openable region 30 in the sheet of film material F, including punching the sheet of film material F to form the access opening 32. If desired, the gripping tab 34 can be formed by folding the piece of film material cut from the access opening, thus forming a folded gripping tab 34. Alternatively, the film material cut from the access opening can be removed for recycling or disposal.

Thereafter, a recloseable fastener assembly 22 is joined to the sheet of film material F at the openable region 30. Package formation is completed by folding the sheet of film material F to form a package body 12 having a top end, a bottom end, a front wall (14), and a back wall (16), with the front wall (14) joined to the back wall (16) by upper and lower seams (18, 20) respectively provided at the top and bottom ends. The recloseable fastener assembly 22 is thus joined to an inside surface of the front wall (14). The recloseable fastener assembly is accessible through the openable region 30, which is facilitated by manipulation of the folding gripping tab 34. While folding of the film material F to form the package is typically effected in conjunction with package filling on a form, fill, and seal apparatus, packages formed in accordance with the present invention can be premade for subsequent filling.

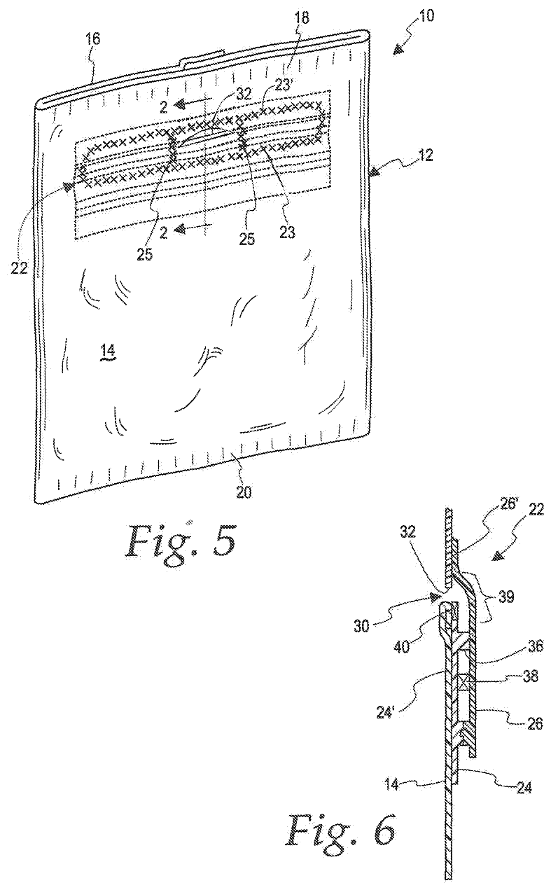

In accordance with another embodiment of the present invention, as illustrated in FIGS. 5 and 6, a recloseable package 10 comprises a package body 12 as described above, including a top end, a bottom end, a front wall 14 and a back wall 16. Upper and lower seams are respectively provided at the top and bottom ends.

In this embodiment, a recloseable fastener assembly 22 is joined to an inside surface of the front wall 14, and comprises first and second interlocking profile strips 24, 26 configured for releasable interlocking engagement with each other by the provision of respective interlocking features comprising at least one protuberance on one of the profile strips, and at least one groove defined by the other of the profile strips for respectively releasably receiving the protuberance portion.

As in the previous embodiment, the first profile strip 24 includes a body flange portion joined at a first seal 24′ to the front wall 14 of the package body 12. The second profile strip 26 includes another body flange portion joined at a second seal 26′ to the front wall 14 of the package body 12, wherein the second seal is located above the first seal.

The recloseable package 10 includes an elongated openable region 30 defined in the front wall 14, aligned with the fastener assembly 22 for providing access to the fastener assembly 22 after opening of the openable region 30.

The front wall 14 of the package body 12 further defines an access opening 32 positioned laterally centrally of the front wall 14, with the access opening 32 formed in the front wall 14 adjacent an upper edge of the first profile strip 24. The access opening 32 facilitates access to the fastener assembly 22 through the front wall of the package body.

As noted, in this embodiment, the portion of the film material which is removed to define the access opening 32 is removed during package manufacture. Thus, the material which is cut to form the access opening 32 is not folded to form a folded gripping tab, as in the previous embodiment.

To facilitate manipulation of the fastener assembly 22, at least one of the body flange portions of the first and second profile strips 24,26 includes at least one stand-off projection 36 engageable with the other one of the body flange portions. This stand-off projection 36 facilitates manipulation and separation the profile strips 24,26 of the fastener assembly 22. The one or more stand-off projections 36 desirably act to separate the body flange portions from each other. Manipulation of the fastener assembly 22 through the access opening 32 is facilitated.

By way of example, the stand-off projection is configured to have a cross-sectional dimension which is great enough to facilitate convenient separation and manipulation of the flange portions of the fastener assembly. In this regard, the interlocking features of the assembly are typically dimensioned on the order of about 0.00625 inches. Thus, it is contemplated that the stand-off projection have a dimension in the range of about 0.030 to about 0.060 inches.

In accordance with the present invention, the fastener assembly 22 of the package preferably includes at least one peelable seal 38 releasably joining the body flange portions of the profile strips 24,26 of the fastener assembly 22. The peelable seal 38 is positioned: beneath the at least one stand-off projection 36, and above the interlocking features of said first and second interlocking profile strips 24,26. The stand-off projection 36 facilitates manipulation of the fastener assembly 22 to facilitate separation of the body flange portions to open the peelable seal 38, separate the interlocking features of the fastener assembly 22, and tear or fracture the openable region 30 to permit access to the contents of the package 10.

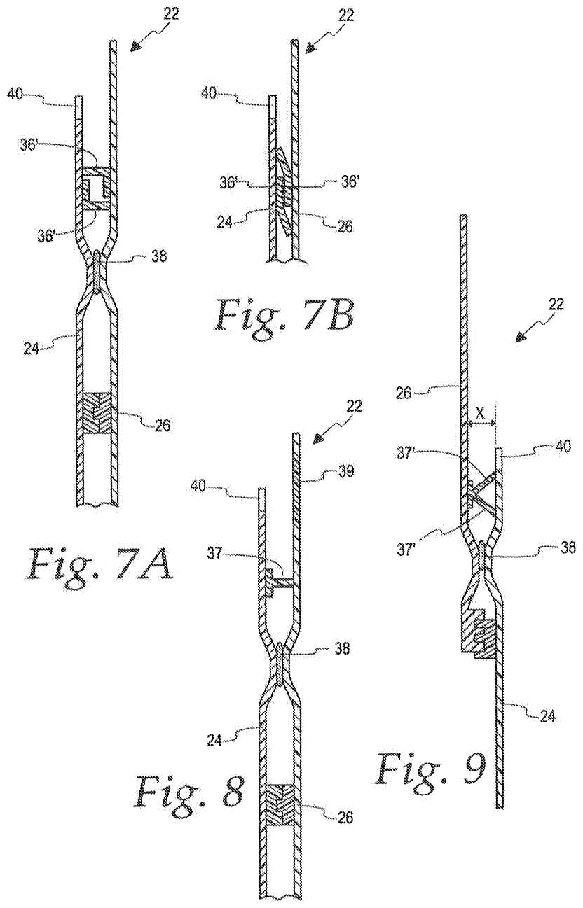

It is presently contemplated that the at least one stand-off projection can be deformable, as designated at 36′, from: a first position to maintain spacing between the body flanges portions (see FIG. 7A), to a second position wherein the body flange portions are more closely spaced together (FIG. 7B). This arrangement facilitates reengagement of the interlocking features of the profile strips 24,26 of the fastener assembly 22, thereby permitting the package 10 to be reclosed after initial opening.

In one illustrated embodiment, a pair of the stand-off projections 36′ are provided, and are respectively positioned on the body flange portions of the fastener assembly 22. In another illustrated embodiment as shown in FIG. 8, the stand-off projection, designated 37, has a generally T-shaped cross-sectional configuration, to thereby readily deform between the first and second positions thereof. In a further embodiment, as shown in FIG. 9, a pair of stand-off projections 37′, 37′ can be provided in a generally V-shaped configuration.

For some applications it can be desirable to configure the body flange portion of the second profile strip 26 to include an opaque region 39 (FIGS. 6, 8) viewable through the access opening 32 defined by the front wall 14 of the package body 12. This opaque region 39 can be colored or tinted, and/or provided with indicia to facilitate opening of the present package. The opaque region 39 can thus be visually discernible from the remainder of that body flange portion. Because the inclusion of tint or other coloring in the polymer from which the profile strip 26 is formed can inhibit its heat-sealing characteristics, it is presently contemplated that any opaque region 39 of the strip be separate from one or more regions which are heat-sealed at the interior of the front wall 14 of the associated package. Co-extrusion techniques can be employed to form profile strips of such a configuration.

It is further contemplated that a free edge portion 40 of at least one of the flange portions of the profile strips of the fastener assembly can be colored to facilitate visual detection of the fastener assembly. In particular, the free edge portion of the first profile strip 24, positioned at the access opening 32 of the package, can facilitate opening of the package by visually showing the region where the package should be gripped for accessing the package contents through the fastener assembly, and for tearing the openable region of the front wall of the package. This coloring can be provided at the access opening 32 in combination with the provision of an opaque or colored region on the second profile strip, such as behind the colored free edge portion of the first profile strip. Again, this identifies the region of the package at which the fastener assembly can be accessed, and can assist visually impaired individuals with locating the access opening of the package.

In accordance with the present invention, the recloseable fastener assembly 22 is secured to the front wall 14 of the package body 12 by a perimeter seal (indicated at cross-hatching) extending generally about the interlocking features of the fastener assembly 22. As shown in FIG. 5, the perimeter seal has a first leg 23 extending below the interlocking features of the assembly, and a second leg 23′ extending above the interlocking features. The fastener assembly 22 is further secured to the front wall 14 by a pair of bridge seals 25 extending between the first and second legs 23,23′ of the perimeter seal, with the bridge seals 25,25 positioned on respective opposite sides of the access opening 32 defined by the front wall 14 of the package body 12. This arrangement desirably tends to isolate the access opening from the portions of the fastener assembly extending behind front wall of the package. Debris is desirably prevented from entering the region between the fastener assembly and the front wall. Enhanced tamper-evidence is also provided.

In accordance with the present invention, a recloseable fastener assembly 22 comprises first and second interlocking profile strips 24,26 respectively extending along the length of the fastener assembly 22.

The profile strips 24,26 are configured for releasable interlocking engagement with each other by the provision respective interlocking features comprising at least one protuberance on one of the profile strips, and at least one groove defined by the other of the profile strips for respectively releasably receiving the protuberance. The first profile strip 24 includes a body flange portion, and second profile strip 26 includes another body flange portion.

In accordance with the present invention, at least one of the body flange portions of the profile strips 24,26 of the fastener assembly 22 includes at least one deformable stand-off projection 36′,37 engageable with the other one of the body flange portions of the fastener to facilitate manipulation of said fastener assembly 22. The at least one stand-off projection 36′,37 is deformable from: a first position to maintain spacing between the body flanges portions, to a second position wherein the body flange portions are more closely spaced together.

The fastener assembly 22 further includes at least one peelable seal 38 releasably joining the body flange portions. The peelable seal 38 is positioned intermediate the at least one stand-off projection, and the interlocking features of the first and second interlocking profile strips 24,26. The peelable seal 38 as shown is pre-activated. The peelable seal can be pre-activated, or can be activated during the method of package manufacture.

In one illustrated embodiment a pair of the stand-off projections 36′,36′ are respectively positioned on the body flange portions of the fastener assembly 22. In another illustrated embodiment, the stand-off projection 37 has a generally T-shaped cross-sectional configuration, to thereby readily deform between the first and second positions thereof. As illustrated in FIG. 9, a pair of deformable stand-off projections 37′, 37′ can be provided on one of the body flange portions in a generally V-shaped configuration, wherein the projections are deformable from a first position, as shown, to maintain spacing between the body flange portions, to a second position wherein the projections 37′ a generally splayed about to permit the body flange portions to be more closely spaced together for reclosing the package.

Optionally, the body flange portion of at least one of the profile strips can include an opaque region which is visually discernible from the remainder of that body flange portion, and/or a free edge portion at one of the body flange portions of the fastener assembly can be colored or tinted to make the fastener assembly readily visually discernible.

In accordance with the present invention, a method of opening a package includes the step of providing a recloseable package 10 as described above, including providing an access opening 32 in a front wall 12 of the package, prior to filling the package. The method further includes providing a peelable seal 38 between flange portions of a fastener assembly 22 of the package

The present method further includes accessing first and second profile strips of the fastener assembly 22 through the access opening 32 in the front wall to facilitate separation of profile strips of the fastener assembly, and unsealing of the peelable seal 38, to gain access to the contents of the package through an openable region 30 of the package front wall. In the preferred practice, the method of opening includes providing the profile strip positioned at the access opening with a free edge portion 40 colored to facilitate visual detection of the fastener assembly.

It will be appreciated that a desirable feature of the present invention is the ability to gain convenient access to the fastener assembly 22 through the access opening 32 in the front wall 14 of the package. Thus, the access opening it dimensioned to permit a user to easily insert a finger or thumb through the front wall to manipulate the fastener assembly. At the same time, it is preferred that the access opening permit the free edge portion of the first profile strip to be viewed through the access opening. Coloring of the free edge portion of this profile strip assists users in identifying the region of the package to be manipulated for opening.

Thus, while the access opening 32 has been shown as formed from a folded or removed portion of the front wall 14, it is within the purview of the present invention that the access opening can be otherwise formed, such a by slitting the front wall without folding or removal of any of the film material. Slitting of the front wall with a heated knife or the like can form an access opening which is large enough to readily permit viewing of the colored free edge of the first profile strip 24, while also permitting a user to easily insert their finger or thumb into the opening for manipulation of the fastener assembly 22.

From the foregoing, it will be observed that numerous modifications and variations be effected without departing from the true spirit and scope of the novel concept of the present invention. It is to be understood that no limitation with respect to the specific embodiments illustrated herein is intended or should be inferred. The disclosure is intended to cover by the appended claims all such modifications as fall within the scope of the claims.

1. A recloseable package, comprising:
a package body formed from at least one rectangular sheet of film material, said package body having:
a top end, a bottom end, a front wall, and a back wall, said front wall being joined to said back wall by upper and lower seams respectively provided at said top and bottom ends; and
a recloseable fastener assembly joined to an inside surface of said front wall and comprising first and second interlocking profile strips respectively extending along the length of the fastener assembly, said profile strips being configured for releasable interlocking engagement with each other by the provision respective interlocking features comprising at least one protuberance on one of said profile strips, and at least one groove defined by the other of said profile strips for respectively releasably receiving said protuberance,
said first profile strip including a body flange portion joined at a first seal to said front wall of said package body, and said second profile strip including another body flange portion joined at a second seal to said front wall of said package body, said second seal located above said first seal;
an elongated openable region defined in said front wall aligned with said fastener assembly for providing access to said fastener assembly after opening of said openable region;
said front wall of said package body defining an access opening positioned laterally centrally of said front wall to facilitate access to said recloseable fastener assembly, said access opening being formed in said front wall of package body prior to placing contents in said package; and
a peelable seal formed between said body flange portions of said first and second profile strips positioned between said access opening defined by said front wall of said package body and said interlocking features of said profile strips, said access opening facilitating manipulation and separation of said profile strip and said peelable seal, wherein a free edge portion of said first profile strip is colored to facilitate visual detection of the fastener assembly positioned at said and is viewable through said access opening.

2. A recloseable package in accordance with claim 1, wherein
package body includes a folded gripping tab positioned at said access opening, said gripping tab comprising a folded portion of said front wall formed from film material cut from said access opening, prior to folding of said gripping tab to define said access opening.

3. A recloseable package in accordance with claim 1, wherein
at least one of said body flange portions of said first and second profile strips includes a stand-off projection engageable with the other one of said body flange portions to facilitate manipulation of said fastener assembly through said access opening.

4. A recloseable package in accordance with claim 3, wherein
said stand-off projection is coextensive with the interlocking feature of the respective one of said first profile strips.

5. A recloseable package in accordance with claim 1, wherein said access opening is formed by removal of a piece of film material from which said front wall is formed.

6. A method of making a recloseable package, comprising the steps of:
providing at least one rectangular sheet of film material;
forming an openable region in said sheet of film material, including cutting said sheet of film material to form an access opening;
joining a recloseable fastener assembly to said sheet of film material at said openable region, said fastener assembly including first and second profiles strips, and a peelable seal formed between said profile strips; and
folding said sheet of film material to form a package body having a top end, a bottom end, a front wall, and a back wall, said front wall being joined to said back wall by upper and lower seals respectively provided at said top and bottom ends of said package body, said recloseable fastener assembly being joined to an inside surface of said front wall with an edge portion of said first profile strip being positioned adjacent to said access opening, so that said recloseable fastener assembly is accessible through said access opening for separating said profile strips and unsealing said peelable seal,
including coloring a free edge portion of one of said profiles strip so that said free edge portion is viewable through said access opening.

7. A recloseable package, comprising:
a package body formed from at least one rectangular sheet of film material, said package body having:
a top end, a bottom end, a front wall, and a back wall, said front wall being joined to said back wall by upper and lower seams respectively provided at said top and bottom ends;
a recloseable fastener assembly joined to an inside surface of said front wall and comprising first and second interlocking profile strips respectively extending along the length of the fastener assembly, said profile strips being configured for releasable interlocking engagement with each other by the provision respective interlocking features comprising at least one protuberance on one of said profile strips, and at least one groove defined by the other of said profile strips for respectively releasably receiving said protuberance;
said first profile strip including a body flange portion joined at a first seal to said front wall of said package body, and said second profile strip including another body flange portion joined at a second seal to said front wall of said package body, said second seal located above said first seal;
an elongated openable region defined in said front wall aligned with said fastener assembly for providing access to said fastener assembly after opening of said openable region;
said front wall of said package body defining an access opening positioned laterally centrally of said front wall adjacent an upper edge of said first profile strip, to facilitate access to said fastener assembly through said openable region of said front wall of said package body, said access opening being formed in said front wall of package body prior to placing contents in said package;
at least one of said body flange portions of said first and second profile strips including a stand-off projection engageable with the other one of said body flange portions to facilitate manipulation of said fastener assembly through said access opening; and
said fastener assembly including at least one peelable seal releasably joining said body flange portions, said peelable seal being positioned: beneath said at least one stand-off projection, and above said interlocking features of said first and second interlocking profile strips.

8. A recloseable package in accordance with claim 7, wherein
said a least one stand-off projection is deformable from: a first position to maintain spacing between said body flanges portions, to a second position wherein said body flange portions are more closely spaced together.

9. A recloseable package in accordance with claim 7, including
a pair of said stand-off projections respectively positioned on said body flange portions of said fastener assembly.

10. A recloseable package in accordance with claim 7, wherein
said body flange portion of said second profile strip includes an opaque region viewable through said access opening defined by said front wall of said package body.

11. A recloseable package in accordance with claim 7, wherein
a free edge portion of said first profile strip positioned at said access opening is colored to facilitate visual detection of the fastener assembly.

12. A recloseable package in accordance with claim 7, wherein
said recloseable fastener assembly is secured to said front wall of said package body by a perimeter seal extending generally about the interlocking features of the fastener assembly, said perimeter seal having a first leg extending below said interlocking features, and a second leg extending above said interlocking features, said fastener assembly being further secured to said front wall by a pair of bridge seals extending between said first and second legs of said perimeter seal, on respective opposite sides of said access opening defined by said front wall of said package body.

13. A recloseable fastener assembly, comprising:
first and second interlocking profile strips respectively extending along the length of the fastener assembly;
said profile strips being configured for releasable interlocking engagement with each other by the provision of respective interlocking features comprising at least one protuberance on one of said profile strips, and at least one groove defined by the other of said profile strips for respectively releasably receiving said protuberance;
said first profile strip including a body flange portion, said second profile strip including another body flange portion;
at least one of said body flange portions of said first and second profile strips including a deformable stand-off projection engageable with the other one of said body flange portions to facilitate manipulation of said fastener assembly through said access opening;
said a least one stand-off projection being deformable from: a first position to maintain spacing between said body flanges portions, to a second position wherein said body flange portions are more closely spaced together; and
said fastener assembly including at least one peelable seal releasably joining said body flange portions, said peelable seal being positioned intermediate said at least one stand-off projection, and said interlocking features of said first and second interlocking profile strips.

14. A recloseable fastener assembly in accordance with claim 13, wherein
a free edge portion of at least one of the flange portions of said profile strips of said fastener assembly is colored to facilitate visual detection of said fastener assembly.

15. A recloseable fastener assembly in accordance with claim 13, including
a pair of said stand-off projections respectively positioned on said body flange portions of said fastener assembly.

16. A recloseable fastener assembly in accordance with claim 13, wherein
said body flange portion of at least one of said profile strips includes an opaque region which is visually discernible from the remainder of that body flange portion.

17. A method of opening a package, comprising the steps of:
providing a package having: a package body having a top end, a bottom end, a front wall, and a back wall, said front wall being joined to said back wall by upper and lower seams respectively provided at said top and bottom ends;
a recloseable fastener assembly joined to an inside surface of said front wall and comprising first and second interlocking profile configured for releasable interlocking engagement with each other, said first profile strip including a body flange portion joined at a first seal to said front wall of said package body, and said second profile strip including another body flange portion joined at a second seal to said front wall of said package body, said second seal located above said first seal;
an elongated openable region defined in said front wall aligned with said fastener assembly for providing access to said fastener assembly after opening of said openable region;
said front wall of said package body defining an access opening positioned laterally centrally of said front wall to facilitate access to said recloseable fastener assembly, said access opening being formed in said front wall of package body prior to placing contents in said package; and
a peelable seal formed between said body flange portions of said first and second profile strips positioned between said access opening defined by said front wall of said package body and said interlocking features of said profile strips, said access opening facilitating manipulation and separation of said profile strip and said peelable seal,
said method including accessing the first and second profile strips of said fastener assembly through said access opening in said from wall to facilitate separation of said profile strips and unsealing of said peelable seal to gain access to the contents of said package through said openable region of said front wall, including providing said first profile strip positioned at said access opening with a free edge portion colored to facilitate visual detection of the fastener assembly.
